(19) United States
(12) Patent Application Publication
(10) Pub. No.: US 2018/0148597 A1
(43) Pub. Date: May 31, 2018

(54) AIR-DRYING TYPE WATER-BORNE PAINT COMPOSITION

(71) Applicant: NIPPON PAINT CO., LTD., Tokyo (JP)

(72) Inventors: Takahiro UJII, Neyagawa-shi (JP); Soichiro YAMASHITA, Neyagawa-shi (JP); Shinya KAWAKAMI, Neyagawa-shi (JP)

(73) Assignee: NIPPON PAINT CO., LTD., Tokyo (JP)

(21) Appl. No.: 15/576,361

(22) PCT Filed: May 25, 2016
(86) PCT No.: PCT/JP2016/065498

§ 371 Date: Nov. 22, 2017

(30) Foreign Application Priority Data
May 26, 2015 (JP) 2015-106404
May 12, 2016 (JP) 2016-096103

(51) Int. Cl. C09D 163/00; C09D 5/02

(52) U.S. Cl. CPC C09D 163/00; C09D 5/022

(57) ABSTRACT

Provided is an air-drying type water-borne paint composition including a water-borne resin (A) and an emulsion (B) of an ethylene-vinyl acetate copolymer having an ethylene content ratio of 5 to 50% by mass, wherein a content of the ethylene-vinyl acetate copolymer is 5 to 50% by mass, relative to a resin solid content in the air-drying type water-borne paint composition. The air-drying type water-borne paint composition may be a two-pack water-borne paint composition including a first agent containing the water-borne resin (A) and a second solution containing a curing agent (C).

### TECHNICAL FIELD

The present invention relates to an air-drying type water-borne paint composition.

### BACKGROUND ART

A paint is sometimes painted on an old coating film (an existing coating film) formed on a surface of an object of interest in, for example, a repainting work. In this case, the paint is required to have good adhesion (cohesiveness) onto the old coating film. However, there is a case where an internal stress is generated upon curing of a new coating film formed by painting to deteriorate the adhesion of the new coating film onto the old coating film, resulting in delamination of the new coating film from the old coating film at the interface therebetween.

Japanese Patent Laying-open No. 2000-037658 (PTD 1) discloses that, as a means for improving the adhesion to an underlaying base, a thermoplastic resin (e.g., a xylene resin, a coumarone-indene resin) is compounded in a solvent-based (organic solvent-based) epoxy resin anti-corrosive paint composition. The thermoplastic resin can act as an agent for relaxing the internal stress.

### CITATION LIST

### Patent Document

PTD 1: Japanese Patent Laying-open No. 2000-037658

### SUMMARY OF INVENTION

### Technical Problems

In recent years, from the viewpoint of reduction in environmental load, a switch from an organic solvent-borne paint to a water-borne paint has been keenly demanded. However, a water-borne paint tends to have poorer adhesion to an old coating film compared with an organic solvent-borne paint. This is because that a water-borne paint contains no organic solvent and therefore cannot dissolve or swell a surface of the old coating film and, in addition, the surface of the old coating film is hydrophobic and therefore is likely to get wet in water. The thermoplastic resin as mentioned above is useful as an internal stress relaxing agent for an organic solvent-borne paint. However, it is difficult to use the thermoplastic resin for the water-borne paint, because the thermoplastic resin is not water-borne.

An object of the present invention is to provide a water-borne paint composition having excellent adhesion to an old coating film.

### Solutions to Problems

The present invention provides an air-drying type water-borne paint composition as mentioned below.

[1] An air-drying type water-borne paint composition including:

a water-borne resin (A); and

an emulsion (B) of an ethylene-vinyl acetate copolymer having an ethylene content ratio of 5 to 50% by mass,

wherein a content of the ethylene-vinyl acetate copolymer is 5 to 50% by mass, relative to a resin solid content in the air-drying type water-borne paint composition.

[2] The air-drying type water-borne paint composition according to [1], wherein the water-borne resin (A) includes a water-borne resin selected from the group consisting of a water-borne acrylic resin (A1), a water-borne epoxy resin (A2) and a water-borne amine resin (A3).

[3] The air-drying type water-borne paint composition according to [2], wherein the water-borne amine resin (A3) is a water-borne epoxy-based amine resin that is an amine-modified product of an epoxy resin.

[4] The air-drying type water-borne paint composition according to [3], wherein the epoxy resin has a molecular weight of greater than or equal to 2000.

[5] The air-drying type water-borne paint composition according to any one of [1] to [4], wherein the air-drying type water-borne paint composition is a two-pack water-borne paint composition including a first agent containing the water-borne resin (A) and a second agent containing a curing agent (C).

[6] The air-drying type water-borne paint composition according to [5], wherein the curing agent (C) includes a compound having a functional group selected from the group consisting of a (meth)acryloyl group, an epoxy group and an amino group.

[7] The air-drying type water-borne paint composition according to [5] or [6], wherein the curing agent (C) is a water-borne curing agent.

[8] The air-drying type water-borne paint composition according to any one of [I] to [7], further including an alkoxysilane compound (D).

### Advantageous Effects of Invention

According to the present invention, an air-drying type water-borne paint composition having excellent adhesion to an old coating film can be provided.

### DESCRIPTION OF EMBODIMENTS

The water-borne paint composition according to the present invention is an air-drying type water-borne paint composition including a water-borne resin (A) and an emulsion (B) of an ethylene-vinyl acetate copolymer. The water-borne paint composition according to the present invention may be of a one-pack type or a two-pack type. In the case where the water-borne paint composition according to the present invention is of a two-pack type, the water-borne paint composition can include a first agent containing the water-borne resin (A) and a second agent containing a curing agent (C). The two-pack water-borne paint composition can be formed into a cured coating film through a curing reaction of the water-borne resin (A) with the curing agent (C) occurring upon mixing of the first agent with the second agent. The water-borne paint composition according to the present invention can be used suitably as, for example, an anti-corrosive paint (including a heavy-duty anti-corrosive paint) or the like.

According to the water-borne paint composition of the present invention, the adhesion (cohesiveness) to an underlaying base, particularly an old coating film, can be improved. The improvement in the adhesion to an underlaying base such as an old coating film results in improvement in anti-corrosion properties of the coating film. According to the water-borne paint composition of the present invention, water resistance of the coating film can also be improved. The term “an old coating film” as used herein refers to an old coating film which was formed on an object in the past and has been subjected to a practical use. The old coating film may be formed from the water-borne paint composition according to the present invention, or may be formed from a paint composition other than the water-borne paint composition according to the present invention. The water-borne paint composition having good adhesion to an old coating film is useful for a case where it is intended to newly form a coating film on a surface of an object of interest including the old coating film or a case where it is intended to apply a refinish coating onto a surface of an object of interest including the old coating film.

<Water-Borne Resin (A)>

The water-borne resin (A) may be a vehicle resin in a one-pack water-borne paint composition, and may be a vehicle resin that is the main component to be contained in a first agent (main agent) in a two-pack water-borne paint composition. The term “water-borne” as used herein refers to “water-soluble” or “water dispersion type”. It is preferred that the water-borne paint composition according to the present invention contains an aqueous solution or an aqueous dispersion (such as an emulsion) of the water-borne resin (A).

From the viewpoint of curability of the water-borne paint composition and water resistance, anti-corrosion properties and adhesion to an old coating of the coating film, a content of the water-borne resin (A) in terms of solid content is preferably 5 to 95% by mass, more preferably 10 to 90% by mass (e.g., 10 to 85% by mass), relative to a resin solid content in the water-borne paint composition. In the case of a one-pack water-borne paint composition, the content of the water-borne resin (A) in terms of solid content is preferably 40 to 95% by mass, more preferably 50 to 85% by mass (e.g., 55 to 800 by mass), relative to the resin solid content in the water-borne paint composition. The term “resin solid content in the water-borne paint composition” refers to the sum of a content of the water-borne resin (A) in terms of solid content, a content of the emulsion (B) of an ethylene-vinyl acetate copolymer in terms of solid content and a content of the curing agent (C) in terms of solid content.

Examples of the water-borne resin (A) include a water-borne acrylic resin (A1), a water-borne epoxy resin (A2) and a water-borne amine resin (A3). The water-borne paint composition according to the present invention may contain two or more types of water-borne resins (A).

(1) Water-Borne Acrylic Resin (A1)

Specific examples of the water-borne acrylic resin (A1) include an anionic acrylic resin emulsion (A1-1), a cationic acrylic resin emulsion (A1-2) and a nonionic acrylic resin emulsion (A1-3). Specific examples of the anionic acrylic resin emulsion (A1-1) include a carboxyl-group-containing acrylic resin emulsion and a silicone-group-containing acrylic resin emulsion. The water-borne paint composition according to the present invention may contain two or more types of water-borne acrylic resins (A1).

A carboxyl-group-containing acrylic resin to be contained in the carboxyl-group-containing acrylic resin emulsion may be a copolymer of a carboxyl-group-containing ethylenically unsaturated monomer (e.g., (meth)acrylic acid) with another ethylenically unsaturated monomer copolymerizable with the above-mentioned carboxyl-group-containing ethylenically unsaturated monomer. The term “(meth)acrylic” as used herein refers to at least one of methacrylic and acrylic. The term “(meth)acrylate” as used herein refers to at least one of methacrylate and acrylate. Only one type of the above-mentioned carboxyl-group-containing ethylenically unsaturated monomer may be used, or a combination of two or more types of the above-mentioned carboxyl-group-containing ethylenically unsaturated monomers may be used. Only one type of the above-mentioned another ethylenically unsaturated monomer may be used, or a combination of two or more types of the above-mentioned another ethylenically unsaturated monomers may be used.

Specific examples of the carboxyl-group-containing ethylenically unsaturated monomer include (meth)acrylic acid, maleic acid, itaconic acid, and a monoester of an ethylenically unsaturated dicarboxylic acid (e.g., ethyl maleate, butyl maleate, ethyl itaconate, butyl itaconate).

Specific examples of the above-mentioned another ethylenically unsaturated monomer copolymerizable with the carboxyl-group-containing ethylenically unsaturated monomer include: a (meth)acrylic acid alkyl ester, such as methyl (meth)acrylate, ethyl (meth)acrylate, n-butyl (meth)acrylate, 2-ethylhexyl (meth)acrylate, cyclopentyl (meth)acrylate and cyclohexyl (meth)acrylate; a hydroxyl-group-containing (meth)acrylic acid alkyl ester, such as 2-hydroxyethyl (meth)acrylate, 2-hydroxypropyl (meth)acrylate, 4-hydroxybutyl (meth)acrylate and a reaction product of 2-hydroxyethyl (meth)acrylate with ε-caprolactone; a (meth)acrylic acid aminoalkyl ester, such as aminoethyl (meth)acrylate, dimethylaminoethyl (meth)acrylate and butylaminoethyl (meth)acrylate; a (meth)acrylic acid aminoalkylamide, such as aminoethyl(meth)acrylamide, dimethylaminomethyl(meth)acrylamide and methylaminopropyl(meth)acrylamide; other amide-group-containing (meth)acrylic monomer, such as (meth)acrylamide, N-methylol(meth)acrylamide, methoxybutyl(meth)acrylamide and diacetone(meth)acrylamide; glycidyl (meth)acrylate, a vinyl cyanide-type monomer, such as (meth)acrylonitrile and α-chloroacrylonitrile; a saturated aliphatic carboxylic acid vinyl ester monomer, such as vinyl acetate and vinyl propionate; and a styrene-type monomer, such as styrene, α-methylstyrene and vinyltoluene.

A silicone-containing acrylic resin to be contained in the silicone-containing acrylic resin emulsion may be a copolymer that contains the above-mentioned carboxyl-group-containing ethylenically unsaturated monomer as well as an alkoxysilyl-group-containing ethylenically unsaturated monomer as copolymerization components.

The alkoxysilyl-group-containing ethylenically unsaturated monomer is preferably one which contains an alkoxysilyl group having 1 to 14 carbon atoms. Specific examples thereof include trimethoxysilylpropyl (meth)acrylate, triethoxysilylpropyl (meth)acrylate, tributoxysilylpropyl (meth)acrylate, dimethoxymethylsilylpropyl (meth)acrylate, methoxydimethylsilylpropyl (meth)acrylate, vinyltrimethoxysilane, vinyltriethoxysilane, vinyldimethoxymethylsilane, vinylmethoxydimethylsilane and vinyltris(β-methoxyethoxy)silane. Only one type of the alkoxysilyl-group-containing ethylenically unsaturated monomer may be used, or a combination of two or more types of the alkoxysilyl-group-containing ethylenically unsaturated monomers may be used.

A cationic acrylic resin to be contained in the cationic acrylic resin emulsion (A1-2) may be a copolymer of an amino-group-containing ethylenically unsaturated monomer with another ethylenically unsaturated monomer copolymerizable with the amino-group-containing ethylenically unsaturated monomer. In this case, the cationic acrylic resin emulsion (A1-2) is an amino-group-containing acrylic resin emulsion. Only one type of the amino-group-containing ethylenically unsaturated monomer may be used, or a combination of two or more types of the amino-group-containing ethylenically unsaturated monomers may be used. Only one type of the above-mentioned another ethylenically unsaturated monomer may be used, or a combination of two or more types of the above-mentioned another ethylenically unsaturated monomers may be used.

Specific examples of the amino-group-containing ethylenically unsaturated monomer include: an amino-group-containing (meth)acrylic acid ester such as dimethylaminoethyl (meth)acrylate; and an amino-group-containing (meth)acrylamide such as (meth)acrylamide, diacetone(meth)acrylamide, N,N-dimethylaminopropyl(meth)acrylamide, N,N-dimethyl(meth)acrylamide, (meth)acryloyl morpholine, N-isopropyl(meth)acrylamide, N,N-diethyl(meth)acrylamide and diethylaminopropyl(meth)acrylamide.

Specific examples of the above-mentioned another ethylenically unsaturated monomer copolymerizable with the amino-group-containing ethylenically unsaturated monomer include: a (meth)acrylic acid alkyl ester, such as methyl (meth)acrylate, ethyl(meth)acrylate, n-butyl (meth)acrylate, 2-ethylhexyl (meth)acrylate, cyclopentyl (meth)acrylate and cyclohexyl (meth)acrylate; an ethylenically unsaturated dicarboxylic acid monoester monomer, such as ethyl maleate, butyl maleate, ethyl itaconate and butyl itaconate; a hydroxyl-group-containing (meth)acrylic acid alkyl ester, such as 2-hydroxyethyl (meth)acrylate, 2-hydroxypropyl (meth)acrylate, 4-hydroxybutyl (meth)acrylate and a reaction product of 2-hydroxyethyl (meth)acrylate with ε-caprolactone; glycidyl (meth)acrylate; a vinyl cyanide-type monomer, such as (meth)acrylonitrile and α-chloroacrylonitrile; a saturated aliphatic carboxylic acid vinyl ester monomer, such as vinyl acetate and vinyl propionate; and a styrene-type monomer, such as styrene, α-methylstyrene and vinyltoluene.

A nonionic acrylic resin to be contained in the nonionic acrylic resin emulsion (A1-3) may be a copolymer of an ethylenically unsaturated monomer. Only one type of the ethylenically unsaturated monomer may be used, or a combination of two or more types of the ethylenically unsaturated monomers may be used.

Specific examples of the ethylenically unsaturated monomer include: a (meth)acrylic acid alkyl ester, such as methyl (meth)acrylate, ethyl(meth)acrylate, n-butyl (meth)acrylate, 2-ethylhexyl (meth)acrylate, cyclopentyl (meth)acrylate and cyclohexyl (meth)acrylate; a hydroxyl-group-containing (meth)acrylic acid alkyl ester, such as 2-hydroxyethyl (meth)acrylate, 2-hydroxypropyl (meth)acrylate, 4-hydroxybutyl (meth)acrylate and a reaction product of 2-hydroxyethyl (meth)acrylate with ε-caprolactone; a (meth)acrylic acid aminoalkyl ester, such as aminoethyl (meth)acrylate, dimethylaminoethyl (meth)acrylate and butylaminoethyl (meth)acrylate; a (meth)acrylic acid aminoalkylamide, such as aminoethyl(meth)acrylamide, dimethylaminomethyl(meth)acrylamide and methylaminopropyl(meth)acrylamide; another amide-group-containing (meth)acrylic monomer, such as (meth)acrylamide, N-methylol(meth)acrylamide, methoxybutyl(meth)acrylamide and diacetone(meth)acrylamide; glycidyl (meth)acrylate; a vinyl cyanide-type monomer, such as (meth)acrylonitrile and α-chloroacrylonitrile: a saturated aliphatic carboxylic acid vinyl ester monomer, such as vinyl acetate and vinyl propionate; and a styrene-type monomer, such as styrene, α-methylstyrene and vinyltoluene.

Each of the anionic acrylic resin emulsion (A1-1) and the cationic acrylic resin emulsion (A1-2) can be prepared by, for example, (1) a method in which a monomer used for forming an acrylic resin is subjected to emulsion polymerization in the presence of an emulsifying agent and a polymerization initiator or (2) a method in which a monomer used for forming an acrylic resin is subjected to solution polymerization in a solvent using a radical polymerization initiator to produce a polymer solution, and then the polymer solution is neutralized with a neutralizing agent to allow extraction by water. The nonionic acrylic resin emulsion (A1-3) can be prepared by (1) a method in which a monomer used for forming an acrylic resin is subjected to emulsion polymerization in the presence of an emulsifying agent and a polymerization initiator. Each of the above-mentioned methods can be carried out under conditions that are well-known by persons skilled in the art.

Examples of the emulsifying agent that can be used in the emulsion polymerization include; an anionic emulsifying agent such as a soap, an alkyl sulfonic acid salt and a polyoxyethylene alkylsulfuric acid salt in the case of the anionic acrylic resin emulsion (A1-1); and a cationic emulsifying agent such as a stearylamine hydrochloride, lauryltrimethylammonium chloride and trimethyloctadecylammonium chloride in the case of the cationic acrylic resin emulsion (A1-2). In addition, a nonionic emulsifying agent, such as a polyoxyethylene alkyl ether, a polyoxyethylene alkylphenyl ether, a polypropylene glycol ethylene oxide adduct, a polyethylene glycol fatty acid ester and a polyoxyethylene sorbitan fatty acid ester, can be used for all of the anionic acrylic resin emulsion (A1-1), the cationic acrylic resin emulsion (A1-2) and the nonionic acrylic resin emulsion (A1-3). Only one type of the emulsifying agent may be used, or a combination of two or more types of the emulsifying agents may be used.

A surfactant having a radically polymerizable carbon-carbon double bond (also referred to as “a reactive emulsifying agent”, hereinafter) can also be used as the emulsifying agent. When the reactive emulsifying agent is used as the emulsifying agent, water resistance of the water-borne paint composition may be improved. Specific examples of the reactive emulsifying agent include: a nonionic surfactant which contains a polyoxyethylene alkyl phenyl ether as the base structure and in which a radically polymerizable propenyl group is introduced into a hydrophobic group, a cationic surfactant having a quaternary ammonium salt structure; and an anionic surfactant containing a sulfonic acid group, a sulfonate group, a sulfuric acid ester group and/or an ethyleneoxy group and having a radically polymerizable carbon-carbon double bond.

The amount of the emulsifying agent to be used is preferably 0.5 to 15% by mass relative to the total amount of monomers to be used in the polymerization of the anionic acrylic resin emulsion (A1-1), the cationic acrylic resin emulsion (A1-2) or the nonionic acrylic resin emulsion (A1-3).

Specific examples of the polymerization initiator that can be used in the emulsion polymerization include: an azo-type initiator such as azobisisobutyronitrile, azobisvaleronitrile and 2,2′-azobis(2-aminodipropane) dihydrochloride; an organic peroxide-type initiator such as benzoyl peroxide, lauryl peroxide and t-butyl peroxide; and hydrogen peroxide. In addition, a redox initiator co-using a reducing agent (e.g., rongalite, L-ascorbic acid, an organic amine) may also be used. Only one type of the polymerization initiator may be used, or a combination of two or more types of the polymerization initiators may be used.

The amount of the polymerization initiator to be used is preferably 0.01 to 10% by mass relative to the total amount of monomers to be used in the polymerization of the anionic acrylic resin emulsion (A1-1), the cationic acrylic resin emulsion (A1-2) or the nonionic acrylic resin emulsion (A1-3). The polymerization temperature and the polymerization time to be employed in the emulsion polymerization are, for example, 30 to 90° C. and 3 to 12 hours, respectively. The concentration of monomers in the polymerization reaction is, for example, 30 to 70% by mass.

Specific examples of the radical polymerization initiator that can be used in the solution polymerization include azobisisobutyronitrile, benzoyl peroxide, t-butyl perbenzoate, t-butyl hydroperoxide, di-t-butyl peroxide and cumene hydroperoxide. Only one type of the radical polymerization initiator may be used, or a combination of two or more types of the radical polymerization initiators may be used. In order to control the resin molecular weight, a chain transfer agent such as octylmercaptan and dodecylmercaptan may be added.

Examples of the neutralizing agent to be used for the neutralization of a polymer produced by the solution polymerization include: an inorganic base and/or an organic base in the case of the anionic acrylic resin emulsion (A1-1); and an inorganic acid and/or an organic acid in the case of the cationic acrylic resin emulsion (A1-2). Specific examples of the inorganic base and the organic base include ammonia, triethylamine, propylamine, dibutylamine, amylamine, 1-aminooctane, 2-dimethylaminoethanol, ethylaminoethanol, 2-diethylaminoethanol, 1-amino-2-propanol, 2-amino-1-propanol, 2-amino-2-methyl-1-propanol, 3-amino-1-propanol, 1-dimethylamino-2-propanol, 3-dimethylamino-1-propanol, 2-propylaminoethanol, ethoxypropylamine, aminobenzyl alcohol, morpholine, sodium hydroxide and potassium hydroxide. Specific examples of the inorganic acid include hydrochloric acid and nitric acid. Specific examples of the organic acid include aliphatic saturated carboxylic acids such as formic acid, acetic acid, propionic acid, butyric acid and lactic acid. Only one type of the neutralizing agent may be used, or a combination of two or more types of the neutralizing agents may be used.

The amount of the neutralizing agent to be used is generally 0.2 to 1.0 mole relative to 1 mole of a carboxyl group or an amino group contained in the copolymer (neutralization ratio: 20 to 100%). As mentioned above, an acrylic resin emulsion, which is one embodiment of an aqueous dispersion of an acrylic resin, can be produced by neutralizing a carboxyl group derived from the carboxyl-group-containing ethylenically unsaturated monomer with a base in the case where the anionic acrylic resin is used, or by neutralizing an amino group derived from the amino-group-containing ethylenically unsaturated monomer with an acid in the case where the cationic acrylic resin is used.

It is also possible to produce a water-soluble water-borne acrylic resin (A1) (an aqueous acrylic resin solution), in which the acrylic resin is dissolved in water, by increasing the neutralization ratio, preferably by increasing the amount of carboxyl groups or amino groups in the copolymer as well as increasing the neutralization ratio. If the neutralization ratio is too small, it is sometimes impossible to prepare a water-borne form (i.e., a form dispersed in water or a form solubilized in water) of the acrylic resin.

The anionic acrylic resin emulsion (A1-1) preferably has an acid value of 5 to 200 mgKOH/g, more preferably 5 to 70 mgKOH/g. If the acid value is less than 5 mgKOH/g, stability of the anionic acrylic resin emulsion (A1-1) in water may be deteriorated. If the acid value exceeds 200 mgKOH/g, water resistance of the resultant coating film may be deteriorated. The acid value means an acid value in terms of solid content, and can be determined by the known method described in JIS K 0070.

The anionic acrylic resin emulsion (A1-1) preferably has a hydroxyl value of 0 to 85 mgKOH/g, more preferably 0 to 40 mgKOH/g. If the hydroxyl value exceeds 85 mgKOH/g, water resistance of the resultant coating film may be deteriorated. The hydroxyl value means a hydroxyl value in terms of solid content, and can be determined by the known method described in JIS K 0070.

The cationic acrylic resin emulsion (A1-2) preferably has an amine value of 10 to 200 mgKOH/g, more preferably 20 to 70 mgKOH/g. If the amine value is less than 10 mgKOH/g, stability of the cationic acrylic resin emulsion (A1-2) in water may be deteriorated. If the amine value exceeds 200 mgKOH/g, water resistance of the resultant coating film may be deteriorated. The amine value means an amine value in terms of solid content, and can be determined by the known method described in JIS K 7237.

The cationic acrylic resin emulsion (A1-2) preferably has a hydroxyl value of 0 to 85 mgKOH/g. If the hydroxyl value exceeds 85 mgKOH/g, water resistance of the resultant coating film may be deteriorated. The hydroxyl value means a hydroxyl value in terms of solid content, and can be determined by the known method described in JIS K 0070.

(2) Water-Borne Epoxy Resin (A2)

A specific example of the water-borne epoxy resin (A2) is an aqueous dispersion of a first epoxy resin, more specifically an emulsion of the first epoxy resin. The emulsion is an epoxy resin emulsion prepared by dispersing the first epoxy resin in an aqueous medium such as water. The emulsion of the first epoxy resin may be of a forcibly emulsified product or a self-emulsified product. The term “epoxy resin” as used herein refers to a compound having at least one epoxy group (e.g., glycidyl group) in a molecule thereof. The number of epoxy groups in the first epoxy resin is preferably greater than or equal to 2, more preferably 2. The water-borne paint composition according to the present invention may contain two or more types of the water-borne epoxy resins (A2).

The first epoxy resin to be contained in the aqueous dispersion (e.g., the emulsion) is preferably a compound having two or more epoxy groups in a molecule. A specific example of the compound is a reaction product of a polyhydric alcohol or a polyhydric phenol with a halohydrin. Specific examples of the first epoxy resin include a bisphenol A-type epoxy resin, a halogenated bisphenol A-type epoxy resin, a novolac-type epoxy resin, a polyglycol-type epoxy resin, a bisphenol F-type epoxy resin, an epoxidized oil, 1,6-hexanediol diglycidyl ether and neopentyl glycol diglycidyl ether. As the first epoxy resin, a combination of two or more types of epoxy resins may be used.

Among these first epoxy resins, a bisphenol A-type epoxy resin and a bisphenol F-type epoxy resin are preferably used as the first epoxy resin, from the viewpoint of adhesion to an old coating film and the anti-corrosion properties and water resistance of the coating film. More preferably, the first epoxy resin contains a bisphenol A-type epoxy resin.

An epoxy equivalent of the first epoxy resin is preferably 150 to 1200, more preferably 150 to 1000. The epoxy equivalent of the first epoxy resin falling within the above-mentioned range is preferred, from the viewpoint of improvement in adhesion to an old coating film and the anti-corrosion properties and water resistance of the coating film. By adjusting the epoxy equivalent of the first epoxy resin, the characteristics of the water-borne paint composition and the physical properties of the coating film can be controlled. The water-borne epoxy resin (A2) is an emulsion of a first epoxy resin containing a bisphenol A-type epoxy resin preferably having an epoxy equivalent of 150 to 1200, more preferably 150 to 1000.

The number average molecular weight of the first epoxy resin is preferably 300 to 3000, more preferably 300 to 2500, in terms of standard polystyrene as determined by gel permeation chromatography (GPC). The number average molecular weight of the first epoxy resin falling within the above-mentioned range is advantageous from the viewpoint of improvement in adhesion to an old coating film and anti-corrosion properties and water resistance of the coating film. By adjusting the molecular weight of the first epoxy resin, the characteristics of the water-borne paint composition and physical properties of the coating film can also be controlled.

The forcibly emulsified emulsion of the first epoxy resin can be produced by stirring and emulsifying the first epoxy resin together with an emulsifying agent in an aqueous medium (e.g., water). The emulsifying agent may be the above-mentioned nonionic emulsifying agent. Only one type of the emulsifying agent may be used, or a combination of two or more types of the emulsifying agents may be used.

The epoxy resin emulsion in which a self-emulsifiable first epoxy resin is used can be produced by emulsifying a resin produced by introducing a hydrophilic moiety into the above-mentioned epoxy resin in an aqueous medium such as water. Specific examples of the hydrophilic moiety include a side chain having a hydroxyl group or a carboxyl group, and a nonionic polyalkylene oxide skeleton.

The water-borne epoxy resin (A2), such as an emulsion of the first epoxy resin, may contain a pH modifier. As the pH modifier, an inorganic acid or an organic acid can be used. Specific examples of the inorganic acid include hydrochloric acid, sulfuric acid, nitric acid and phosphoric acid. Specific examples of the organic acid include formic acid and acetic acid. Only one type of the pH modifier may be used, or a combination of two or more types of the pH modifiers may be used.

Among these pH modifiers, phosphoric acid is used preferably. When the pH value of the water-borne epoxy resin (A2) is adjusted to preferably less than 5, more preferably less than 4.5, using phosphoric acid, the anti-corrosion properties of the coating film can be improved. It is presumed that this is because a passive film is formed on a surface of an object to be painted.

(3) Water-Borne Amine Resin (A3)

The water-borne amine resin (A3) is a water-soluble or water dispersion type resin having at least one amino group selected from the group consisting of a primary amino group and a secondary amino group in a molecule thereof, and is preferably of a water dispersion type. The water-borne amine resin (A3) may be, for example, a water-borne epoxy-based amine resin (A3-1) prepared by an amine modification of a second epoxy resin or a water-borne acrylic amine resin (A3-2) prepared by an amine modification of an acrylic resin, and is preferably a water-borne epoxy-amine resin (A3-1), more preferably a water dispersion type water-borne epoxy-based amine resin (A3-1), from the viewpoint of curability of the water-borne paint composition and water resistance, anti-corrosion properties and adhesion to an old coating of the coating film. The water-borne paint composition according to the present invention may contain two or more types of the water-borne amine resins (A3).

In the case where the water-borne amine resin (A3) is of a water dispersion type, when the water-borne paint composition is of a two-pack type, homogeneous mixing of the first agent containing the water-borne amine resin (A3) with the second agent containing the curing agent (C) can be achieved easily, and rapid progression of the reaction between the water-borne amine resin (A3) and the curing agent (C) in the second agent can be prevented to achieve moderate reaction progress. As a result, a water-borne paint composition having a long pot life can be obtained. More specifically, in the case where the water-borne amine resin (A3) is of a water dispersion type, the water-borne amine resin (A3) in the first agent is less likely to contact with the curing agent (C) in the second agent of the water-borne paint composition that is not subjected to painting yet even after mixing of the first agent containing the water-borne amine resin (A3) with the second agent. As a result, the reaction between the water-borne amine resin (A3) and the curing agent (C) does not proceed in the water-borne paint composition even after mixing of the first agent with the second agent, leading to good storage properties and coating properties of the water-borne paint composition. On the other hand, after painting of the water-borne paint composition, a dispersion medium (e.g., water) is evaporated, and therefore the water-borne amine resin (A3) is more likely to contact with the curing agent (C) in the second agent. Therefore, the curing reaction can proceed even at ambient temperature (25° C. or a temperature around 25° C.) or a temperature lower than ambient temperature to form a coating film.

From the viewpoint of curability of the water-borne paint composition, the water-borne amine resin (A3) preferably has two or more amino groups selected from the group consisting of a primary amino group and a secondary amino group. The number of the amino groups may be greater than or equal to 3, or greater than or equal to 4. For example, the water-borne epoxy-based amine resin (A3-1) has 1 or more (e.g., 2 or more) amino groups at one terminal thereof and 1 or more (e.g., 2 or more) amino groups at the other terminal thereof.

The water-borne amine resin (A3) preferably has an amine equivalent (the equivalent of an amino group) of 100 to 3000, more preferably 500 to 2000, still more preferably 600 to 1900, particularly preferably 800 to 1800. The use of a water-borne epoxy-based amine resin (A) having an amine equivalent that falls within the above-mentioned range is advantageous from the viewpoint of improvement in adhesion to an old coating film, curability of the water-borne paint composition and/or flexibility (toughness) of the coating film and impact resistance of the coating film. If the amine equivalent is less than 100, water resistance of the coating film tends to be deteriorated. If the amine equivalent exceeds 3000, phase separation between the amine resin and water may occur and consequently the water-borne amine resin (A-3) may not be produced By adjusting the amine equivalent of the water-borne amine resin (A3), characteristics of the water-borne paint composition and physical properties of the coating film can also be controlled.

The water-borne amine resin (A3) may include two or more types of the water-borne amine resins (A3) having different amine equivalents from each other A preferred embodiment in which two or more types of the water-borne epoxy-based amine resins (A3-1) having different amine equivalents from each other are used is a case where the water-borne amine resin (A3) includes a water-borne epoxy-based amine resin (A3-1a) having an amine equivalent of 500 to 1300 and a water-borne epoxy-based amine resin (A3-1b) having an amine equivalent of 1400 to 2000 When the water-borne epoxy-based amine resin (A3-1a) and the water-borne epoxy-based amine resin (A3-1b) are used in combination, adhesion to an old coating film and water resistance of the coating film may be further improved.

From the viewpoint of adhesion to an old coating film and water resistance of the coating film, the amine equivalent of the water-borne epoxy-based amine resin (A3-1a) is preferably 600 to 1300, more preferably 800 to 1300 and the amine equivalent of the water-borne epoxy-based amine resin (A3-1b) is preferably 1400 to 1800, more preferably 1400 to 1700. From the viewpoint of adhesion to an old coating film and water resistance of the coating film, the content ratio of the water-borne epoxy-based amine resin (A3-1a) to the water-borne epoxy-based amine resin (A3-1b) is preferably 8/2 to 2/8 by mass, more preferably 7/3 to 3/7 by mass.

The term “amine equivalent” as used herein refers to a molecular weight (in terms of a resin solid content) of the water-borne amine resin (A3) per one primary amino group when the water-borne amine resin (A3) has a primary amino group (including the case where the amine resin (A3) contains both of a primary amino group and a secondary amino group), and also refers to a molecular weight (in terms of a resin solid content) of the water-borne amine resin (A3) per one secondary amino group when the water-borne amine resin (A3) has no primary amino groups. The amine equivalent of the water-borne amine resin (A3) can be determined from used amounts of raw materials.

The number average molecular weight of the water-borne amine resin (A3) is preferably 500 to 20000, more preferably 1000 to 10000, in terms of standard polystyrene as determined by gel permeation chromatography (GPC). In the case where the water-borne paint composition is of a two-pack type, when the number average molecular weight of the water-borne amine resin (A3) falls within the above-mentioned range, homogeneous mixing of the first agent containing the water-borne amine resin (A3) with the second agent containing the curing agent (C) can be achieved easily and consequently a coating film having uniform curability and therefore uniform strength can be produced. The number average molecular weight of the water-borne amine resin (A3) falling within the above-mentioned range is also advantageous from the viewpoint of improvement in impact resistance, water resistance, anti-corrosion properties and adhesion to an old coating film of the coating film. By adjusting the molecular weight of the water-borne amine resin (A3), characteristics of the water-borne paint composition and physical properties of the coating film can also be controlled.

A glass transition temperature of the water-borne amine resin (A3) is, for example, −50 to 100° C., preferably 0 to 50° C.

The water-borne epoxy-based amine resin (A3-1) prepared by the amine modification of the second epoxy resin or the water-borne acrylic amine resin (A3-2) prepared by the amine modification of the acrylic resin is preferably a water-borne polyamine resin having two or more amino groups selected from the group consisting of a primary amino group and a secondary amino group. The number of epoxy groups in the second epoxy resin is preferably greater than or equal to 2, more preferably 2. Specific examples of the second epoxy resin include a bisphenol A-type epoxy resin and a bisphenol F-type epoxy resin, and a bisphenol A-type epoxy resin is preferred. As the second epoxy resin, a combination of two or more types of epoxy resins may be used.

The acrylic resin that can form the water-borne acrylic amine resin (A3-2) is preferably an acrylic resin that is obtained by copolymerizing a monomer composition containing a radically polymerizable monomer having an epoxy group and/or a glycidyl group. Specific examples of the radically polymerizable monomer having an epoxy group and/or a glycidyl group include glycidyl (meth)acrylate, methylglycidyl (meth)acrylate and 3,4-epoxycyclohexyl methyl (meth)acrylate.

The amine equivalent of the water-borne amine resin (A3) can be controlled by adjusting the molecular weight of the water-borne amine resin (A3) or the amount of the primary amino group and/or the secondary amino group to be introduced by the amine modification.

The second epoxy resin may be a resin in which a molecular weight is increased or the resin is modified by the chain extension utilizing a reaction of an active hydrogen-containing compound capable of reacting with an epoxy group with an epoxy group. Specific examples of the active hydrogen-containing compound include bifunctional compounds such as a dimer acid, a diamine and a polyether polyol. The second epoxy resin may also be a resin having a fatty acid added thereto. When a fatty acid is added, it becomes possible to introduce a soft component into the resin. In this case, flexibility and impact resistance of the coating film and adhesion to an old coating film can be improved. It also becomes possible to modify (reduce) reactivity of the second epoxy resin by decreasing the number of sites to be amine-modified (i.e., the number of epoxy groups) through the addition of a fatty acid.

An epoxy equivalent of the second epoxy resin is preferably 180 to 3800, more preferably 400 to 3200, still more preferably 700 to 3200. The epoxy equivalent of the second epoxy resin falling within the above-mentioned range is advantageous from the viewpoint of improvement in adhesion to an old coating film and water resistance and anti-corrosion properties of the coating film. If the epoxy equivalent of the second epoxy resin is less than 180, there is such a tendency that water resistance of the coating film is deteriorated. If the epoxy equivalent of the second epoxy resin exceeds 3800, a phase separation between the epoxy-based amine resin and water may occur and therefore the water-borne epoxy-based amine resin (A3-1) may not be produced. The epoxy equivalent of the epoxy resin can be determined in accordance with JIS K 7236.

From the viewpoint of adhesion to an old coating film and water resistance and anti-corrosion properties of the coating film, the molecular weight of the second epoxy resin is preferably greater than or equal to 2000, more preferably 2000 to 7600, still more preferably 3000 to 7000. If the molecular weight of the second epoxy resin exceeds 7600, phase separation between the epoxy-based amine resin and water may occur and consequently the water-borne epoxy-based amine resin (A3-1) may not be produced. The molecular weight of the second epoxy resin can be expressed by the formula: n×(the epoxy equivalent of the second epoxy resin) wherein n represents the number of epoxy groups in a molecule of the second epoxy resin.

Specific examples of a method for the amine modification of the second epoxy resin or the acrylic resin include (1) a method in which a primary-amino-group-containing polyamine is added to the second epoxy resin or the acrylic resin and (2) a method in which a ketiminated amino-group-containing compound is added to the second epoxy resin or the acrylic resin. The amine resin prepared by each of the above-mentioned methods is a polyamine resin having at least one primary amino group and/or at least one secondary amino group and a secondary hydroxyl group in a molecule thereof. A resin that is further modified by reacting a compound having a functional group (e.g., an epoxy group, an acid anhydride group, an acid halogen group, an isocyanate group, a (meth)acryloyl group) with some of the primary amino groups, the secondary amino groups and/or the hydroxyl groups in the polyamine resin may be used as the water-borne amine resin (A3). When the thus produced water-borne amine resin (A3) is used alone or in combination with another resin, it becomes possible to modify physical properties of the resultant coating film.

More specifically, the above-mentioned method (1) is a method in which the primary amino group in the primary-amino-group-containing polyamine is reacted with the epoxy group in the second epoxy resin or a reactive group (e.g., an epoxy group) in the acrylic resin to form a secondary amino group, thereby producing the above-mentioned polyamine resin having the secondary amino group. Specific examples of the primary-amino-group-containing polyamine include diethylenetriamine, dipropylenetriamine, dibutylenetriamine and triethylenetetramine. Only one type of the primary-amino-group-containing polyamine may be used, or a combination of two or more types of the primary-amino-group-containing polyamines may be used.

More specifically, the above-mentioned method (2) is a method in which a ketiminated amino-group-containing compound is reacted with the second epoxy resin or the acrylic resin and then a ketimine group is hydrolyzed to form a primary amino group, thereby producing the above-mentioned polyamine resin having the primary amino group. In the reaction of the ketiminated amino-group-containing compound with the second epoxy resin or the acrylic resin, a secondary amine such as diethanolamine, methylethanolamine or diethylamine may be co-existed in the reaction system.

The ketiminated amino-group-containing compound can be produced by reacting a primary-amino-group-containing compound with a ketone. Specific examples of the primary-amino-group-containing compound include: a primary-amino-group-containing polyamine such as diethylenetriamine, dipropylenetriamine, dibutylenetriamine and triethylenetetramine; and aminoethylethanolamine, methylaminopropylamine and ethylaminoethylamine. Only one type of primary-amino-group-containing compound may be used, or a combination of two or more types of primary-amino-group-containing compounds may be used. Specific examples of the ketone include methyl ethyl ketone, acetone and methyl isobutyl ketone.

The water-borne amine resin (A3) may be a neutralization product produced by neutralizing an amino group with an acid. This neutralization with an acid can be applied to, for example, a case where an amine resin produced by the amine modification of an epoxy resin or an acrylic resin is not in a water-borne form and it is intended to convert the epoxy-based amine resin into a water-borne form.

The type of the acid and the neutralization ratio may be selected appropriately depending on the desired form of the water-borne amine resin (A3) (e.g., a water-soluble form, a water dispersion type). Specific examples of the acid include acetic acid, formic acid, lactic acid and phosphoric acid. The term “neutralization ratio” as used herein refers to a ratio of the number of moles of amino groups to be neutralized with the acid to the total number of moles of amino groups in the epoxy-based amine resin, which is expressed in percentage. The neutralization ratio is, for example, 10 to 80%, preferably 20 to 70%0, more preferably 20 to 60%. When the neutralization ratio falls within the above-mentioned range, it becomes possible to produce a water-borne form, particularly a water dispersion type, of water-borne amine resin (A3) easily.

<Emulsion (B) of Ethylene-Vinyl Acetate Copolymer>

The water-borne paint composition according to the present invention contains an emulsion (B) of an ethylene-vinyl acetate copolymer (also referred to as a “EVA”, hereinafter). In the case where the water-borne paint composition according to the present invention is of a two-pack type, the emulsion (B) of an EVA may be contained in the first agent, or may be contained in the second agent. In the case where the water-borne paint composition according to the present invention is of a two-pack type, the emulsion (B) of an EVA may be added to the first agent or the second agent prior to mixing of the first agent with the second agent, or may be added after mixing of the first agent with the second agent. When the emulsion (B) of an EVA is contained, it becomes possible to improve adhesion to an old coating film. The improvement in adhesion to an old coating film can lead to the improvement in anti-corrosion properties of the coating film. When the emulsion (B) of an EVA is contained, it also becomes possible to improve flexibility of the coating film, and therefore it also becomes possible to improve impact resistance of the coating film.

The emulsion (B) of an EVA can be produced by carrying out an emulsion polymerization of an ethylene monomer with a vinyl acetate monomer in the presence of an emulsifying agent and a radical polymerization initiator. The emulsion (B) of an EVA to be used may be a commercially available product.

From the viewpoint of adhesion to an old coating film, the ethylene content ratio in the EVA is 5 to 50% by mass, preferably 5 to 40% by mass (e.g., 10 to 30% by mass). Consequently, the vinyl acetate content ratio in the EVA is 50 to 95% by mass, preferably 60 to 95% by mass (e.g., 70 to 90% by mass). The concentration of a solid matter in the emulsion (B) of an EVA is, for example, 20 to 60% by mass. The emulsion (B) of an EVA may contain two or more EVAs having different ethylene content ratios from each other.

From the viewpoint of adhesion to an old coating film, the content of the EVA in the water-borne paint composition is 5 to 50% by mass, preferably 5 to 40% by mass, more preferably 10 to 35% by mass, relative to a resin solid content in the water-borne paint composition. The content of the EVA refers to the content of the EVA in terms of solid content in the emulsion (B).

<Curing Agent (C)>

In the case where the water-borne paint composition according to the present invention is of a two-pack type, the water-borne paint composition can contain a curing agent (C). In this case, the water-borne paint composition according to the present invention can be composed of a first agent containing the water-borne resin (A) and a second agent containing the curing agent (C). The water-borne paint composition according to the present invention may contain two or more types of curing agents (C).

The curing agent (C) is a compound having a functional group having reactivity with a functional group in the water-borne resin (A) contained in the first agent (wherein the functional group in the water-borne resin (A) contained in the first agent is referred to as a “first functional group” and the functional group having above-mentioned reactivity with the first functional group is referred to as a “second functional group”, hereinafter). The curing agent (C) is preferably a water-borne, i.e., water-soluble or water dispersion type curing agent. Specific examples of the second functional group having reactivity with the first functional group in the water-borne resin (A) include an epoxy group (e.g., a glycidyl group), a (meth)acryloyl group, an amino group, an isocyanate group and a carboxyl group. The curing agent (C) has at least one, preferably at least two (e.g, two to four), second functional groups in a molecule thereof. The curing agent (C) preferably includes a compound having a functional group (second functional group) selected from the group consisting of a (meth)acryloyl group, an epoxy group and an amino group.

For example, in the case where the water-borne resin (A) contains the above-mentioned carboxyl-group-containing acrylic resin emulsion or the above-mentioned silicone-group-containing acrylic resin emulsion, the curing agent (C) can be a curing agent having an epoxy group as the second functional group.

The curing agent having an epoxy group is preferably an epoxy resin having at least two epoxy groups in a molecule thereof. As the curing agent, a conventional known curing agent may be used, and the above-mentioned water-borne epoxy resin (A2) can be used preferably. With respect to the concrete description of the water-borne epoxy resin (A2) for use as the curing agent, refer to the description for the water-borne resin (A).

For example, in the case where the water-borne resin (A) includes the above-mentioned amino-group-containing acrylic resin emulsion, the curing agent (C) may be a curing agent having an epoxy group as the second functional group, a curing agent having a (meth)acryloyl group as the second functional group, and/or a curing agent having an isocyanate group as the second functional group. The curing agent having an epoxy group is preferably an epoxy resin having at least two epoxy groups in a molecule thereof. As this curing agent, a conventional known curing agent may be used, and the above-mentioned water-borne epoxy resin (A2) can be used preferably. The curing agent having a (meth)acryloyl group is preferably a compound having at least two (meth)acryloyl groups in a molecule thereof [i.e., a (meth)acryloyl-group-containing compound]. In this case, the curing agent (C) is preferably an aqueous dispersion or an aqueous solution of the (meth)acryloyl-group-containing compound. With respect to the concrete description of the water-borne epoxy resin (A2) for use as the curing agent, refer to the description for the water-borne resin (A).

The molecular weight of the (meth)acryloyl-group-containing compound is preferably 150 to 2000, more preferably 200 to 1700, still more preferably 250 to 1300.

The number of (meth)acryloyl groups in the (meth)acryloyl-group-containing compound is greater than or equal to 1, preferably 2 to 4. The viscosity of the (meth)acryloyl-group-containing compound at 25° C. is, for example, less than or equal to 3000 mPa·s, preferably 50 to 3000 mPa·s.

Specific examples of the (meth)acryloyl-group-containing compound include: a polymerizable unsaturated monocarboxylic acid ester compound of a polyhydric alcohol, such as ethylene glycol di(meth)acrylate, triethylene glycol di(meth)acrylate, tetraethylene glycol di(meth)acrylate, 1,3-butylene glycol di(meth)acrylate, trimethylolpropane tri(meth)acrylate, 1,4-butanediol di(meth)acrylate, neopentyl glycol di(meth)acrylate, 1,6-hexanediol di(meth)acrylate, pentaerythritol di(meth)acrylate, pentaerythritol tri(meth)acrylate, pentaerythritol tetra(meth)acrylate, glycerol di(meth)acrylate, glycerol acryloyloxydimethacrylate, 1,1,1-trishydroxymethylethane di(meth)acrylate, 1,1,1-trishydroxymethylethane tri(meth)acrylate and 1,1,1-trishydroxymethylpropane di(meth)acrylate; an adduct of an epoxy-group-containing ethylenically unsaturated monomer with a carboxyl-group-containing ethylenically unsaturated group monomer, such as a reaction product of glycidyl (meth)acrylate with (meth)acrylic acid, crotonic acid or maleic acid; and a polymerizable unsaturated monocarboxylic acid amide compound of a polyvalent amine, such as ethylenediamine di(meth)acrylate. Only one type of the (meth)acryloyl-group-containing compound may be used, or a combination of two or more types of the (meth)acryloyl-group-containing compounds may be used.

The (meth)acryloyl-group-containing compound may be of a water-soluble type, a self-emulsifiable type or a water-insoluble type. Under room temperature, 5 g of the (meth)acryloyl-group-containing compound is added to 100 g of water, then the obtained mixture is stirred for 3 minutes, then the mixture is allowed to leave for 5 minutes and then the resultant mixture is observed with naked eyes. When precipitates are formed in the mixture, the (meth)acryloyl-group-containing compound is determined as being “water-insoluble”; when no precipitate is formed in the mixture and therefore the mixture is clear, the (meth)acryloyl-group-containing compound is determined as being “water-soluble”; and when no precipitate is formed in the mixture but the mixture is cloudy, the (meth)acryloyl-group-containing compound is determined as being “self-emulsifiable”.

In the case where the (meth)acryloyl-group-containing compound is water-soluble, the aqueous dispersion or the aqueous solution may be an aqueous solution of the (meth)acryloyl-group-containing compound. In the case where the (meth)acryloyl-group-containing compound is self-emulsifiable or water-insoluble, the aqueous dispersion or the aqueous solution may be an aqueous dispersion (e.g., an emulsion) of the (meth)acryloyl-group-containing compound. In the preparation of the aqueous dispersion, an emulsifying agent, a dispersant, a water-borne resin and the like may be used. In the preparation of the aqueous dispersion, a treatment for diluting the (meth)acryloyl-group-containing compound with an organic solvent may be carried out.

Specific examples of the emulsifying agent that can be used in the preparation of an aqueous dispersion (an emulsion) of the (meth)acryloyl-group-containing compound include a nonionic emulsifying agent and an anionic emulsifying agent. Specific examples of the nonionic emulsifying agent include a polyoxyethylene alkylphenol ether, a polyoxyethylene styrenated phenyl ether, a polyoxyethylene alkyl ether, a polyoxyethylene polyoxypropylene block polymer and a sorbitan fatty acid ester. Specific examples of the anionic emulsifying agent include a dodecylbenzenesulfonic acid salt, a dialkylsuccinatesulfonic acid salt, a polyoxyethylene alkylethersulfuric acid ester salt, a polyoxyethylene styrenated phenyl ether sulfuric acid ester salt and an alkyldiphenylether disulfonic acid salt.

Specific examples of the dispersant that can be used in the preparation of an aqueous dispersion of the (meth)acryloyl-group-containing compound include a polyacrylic acid sodium salt, an ammonium salt of a half ester of a styrene maleic acid copolymer, and a polyethylene oxide adduct of a half ester of a styrene maleic acid copolymer. A specific example of the water-borne resin that can be used in the preparation of an aqueous dispersion of the (meth)acryloyl-group-containing compound is a sodium salt of a polyacrylic acid ester. In the case where the water-borne paint composition is of a two-pack type, the dispersant, the emulsifying agent or the water-borne resin may be added to the second agent (curing agent).

Specific examples of the organic solvent that can be usedfor dilution of the (meth)acryloyl-group-containing compound include ethylene glycol monobutyl ether and diethylene glycol monobutyl ether.

The (meth)acryloyl-group-containing compound may be modified with a polyalkylene oxide (e.g., polyethylene oxide) so as to increase hydrophilic property by increasing the number of moles of polyalkylene oxide units added thereto, thereby converting the (meth)acryloyl-group-containing compound into water-soluble or self-emulsifiable.

Specific examples of the water-soluble (meth)acryloyl-group-containing compound include ethoxylated bisphenol A diacrylate (EO30 mol), ethoxylated trimethylolpropane triacrylate (EO20 mol), ethoxylated trimethylolpropane triacrylate (EO30 mol), ethoxylated pentaerythritol tetraacrylate (EO35 mol), ethoxylated glycerin triacrylate (EO20 mol) and ethoxylated bisphenol A dimethacrylate (EO30 mol). Only one type of the water-soluble (meth)acryloyl-group-containing compound may be used, or a combination of two or more types of the water-soluble (meth)acryloyl-group-containing compounds may be used. For example, the wording “EO30 mol” as used herein means that 30 ethylene oxide units are contained in a molecule. The term “PO” represents propylene oxide.

Specific examples of the self-emulsifiable (meth)acryloyl-group-containing compound include polyethylene glycol #400 diacrylate (EO9 mol), polyethylene glycol #600 diacrylate (EO14 mol), polyethylene glycol #1000 diacrylate (EO23 mol), ethoxylated bisphenol A diacrylate (EO10 mol), ethoxylated bisphenol A diacrylate (EO20 mol), ethoxylated glycerin triacrylate (EO9 mol) and polyethylene glycol #1000dimethacrylate (EO23 mol). Only one type of the self-emulsifiable (meth)acryloyl-group-containing compound may be used, or a combination of two or more types of the self-emulsifiable (meth)acryloyl-group-containing compounds may be used.

Specific examples of the water-insoluble (meth)acryloyl-group-containing compound include polyethylene glycol #200 glycol diacrylate (EO4 mol), ethoxylated bisphenol A diacrylate (EO3 mol), ethoxylated bisphenol A diacrylate (EO4 mol), propoxylated bisphenol A diacrylate (PO3 mol), 1,10-decanediol diacrylate, tricyclodecanedimethanol diacrylate, ethoxylated 2-methyl-1,3-propanediol diacrylate (EO2 mol), neopentyl glycol diacrylate, 1,6-hexanediol diacrylate, 1,9-nonanediol diacrylate, dipropylene glycol diacrylate (PO2 mol), tripropylene glycol diacrylate (PO3 mol), polypropylene glycol #400 diacrylate (PO7 mol), polypropylene glycol #700 diacrylate (PO12 mol), ethoxylated trimethylolpropane triacrylate (EO3 mol), ethoxylated trimethylolpropane triacrylate (EO9 mol), trimethylolpropane triacrylate, propoxylated trimethylolpropane triacrylate (PO3 mol), pentaerythritol triacrylate, ethoxylated pentaerythritol tetraacrylate (EO4 mol), ditrimethylolpropane tetraacrylate, propoxylated pentaerythritol tetraacrylate (PO4 mol), propoxylated bisphenol A diacrylate (PO4 mol), ethylene glycol dimethacrylate (EO1 mol), diethylene glycol dimethacrylate (EO2 mol), triethylene glycol dimethacrylate (EO3 mol), tetraethylene glycol dimethacrylate (EO4 mol), polyethylene glycol #400 dimethacrylate (EO9 mol), polyethylene glycol #600 dimethacrylate (EO14 mol), 1,3-butanediol dimethacrylate, 1,4-butanediol dimethacrylate, 1,6-hexanediol dimethacrylate, 1,9-nonanediol dimethacrylate, ethoxylated bisphenol A dimethacrylate (EO2.6 mol), ethoxylated bisphenol A dimethacrylate (EO4 mol), ethoxylated bisphenol A dimethacrylate (EO6 mol), ethoxylated bisphenol A dimethacrylate (EO10 mol), ethoxylated bisphenol A dimethacrylate (EO17 mol), neopentyl glycol dimethacrylate, ethoxylated polypropylene glycol #700 dimethacrylate (PO12 mol, EO6 mol), glycerin dimethacrylate, tripropylene glycol dimethacrylate (PO3 mol), polypropylene glycol #400 dimethacrylate (PO7 mol), trimethylolpropane trimethacrylate and ethoxylated trimethylolpropane trimethacrylate (EO9 mol). Only one type of the water-insoluble (meth)acryloyl-group-containing compound may be used, or a combination of two or more types of the water-insoluble (meth)acryloyl-group-containing compounds may be used.

For example, in the case where the water-borne resin (A) includes the water-borne epoxy resin (A2), the curing agent (C) may be a curing agent having an amino group as the second functional group, a curing agent having an isocyanate group as the second functional group and/or a curing agent having a carboxyl group as the second functional group. A curing agent having a (meth)acryloyl group as the second functional group is as described above.

The curing agent having an amino group is preferably a polyamine resin having two or more amino groups in a molecule thereof, more preferably an emulsion of the polyamine resin. Specific examples of the polyamine resin include: an aliphatic polyamine such as ethylenediamine, trimethylenediamine, tetramethylenediamine, pentamethylenediamine, triaminopropane, diethylenetriamine, triethylenetetramine, tetraethylenepentamine, isophoronediamine and 1,3-bisaminomethylcyclohexane; an aromatic polyamine such as phenylenediamine, metaxylylenediamine, paraxylylenediamine and diaminodiphenylmethane, and another polyamine compound such as polyoxyethylenediamine, polyoxypropylenediamine, triethyleneglycoldiamine and tripropyleneglycoldiamine.

The curing agent having an amino group may be the above-mentioned water-borne amine resin (A3). When the water-borne amine resin (A3) is used as the curing agent, adhesion to an old coating film and water resistance and anti-corrosion properties of the coating film may be improved. Among the water-borne resins (A3), the water-borne epoxy-based amine resin (A3-1) is preferably used. With respect to the concrete description of the water-borne amine resin (A3) for use as the curing agent, refer to the description for the water-borne resin (A).

For example, in the case where the water-borne resin (A) includes the water-borne amine resin (A3), the curing agent (C) may be a curing agent having an epoxy group as the second functional group, a curing agent having a (meth)acryloyl group as the second functional group and/or a curing agent having an isocyanate group as the second functional group. These curing agents are as described above.

An equivalent ratio of the second functional group of the curing agent (C) to the first functional group of the water-borne resin (A) (i.e., a (second functional group)/(first functional group)) is preferably 0.7 to 2.5, more preferably 0.8 to 2.0. If the equivalent ratio is less than 0.7, curability of the water-borne paint composition may be deteriorated. If the equivalent ratio exceeds 2.5, adhesion to an old coating film and water resistance of the coating film may be deteriorated.

<Alkoxysilane Compound (D)>

The water-borne paint composition according to the present invention can further contain an alkoxysilane compound (D). In the case where the water-borne paint composition according to the present invention is of a two-pack type, the alkoxysilane compound (D) may be contained in the first agent, or may be contained in the second agent. In the case where the water-borne paint composition according to the present invention is of a two-pack type, the alkoxysilane compound (D) may be added to the first agent or the second agent prior to mixing of the first agent with the second agent, or may be added after mixing of the first agent with the second agent. When the alkoxysilane compound (D) is contained, adhesion to an underlying base (e.g, an old coating film, a surface of an object to be painted) can be further improved. The improvement in adhesion to an underlying base can lead to improvement in anti-corrosion properties of the coating film.

The alkoxysilane compound (D) has both of a functional group having reactivity with or affinity for an organic substance and a functional group having reactivity with or affinity for an inorganic substance. Specific examples of the functional group having reactivity with or affinity for an organic substance include a vinyl group, an epoxy group, a (meth)acrylic group, an amino group and a mercapto group. Specific examples of the functional group having reactivity with or affinity for an inorganic substance include alkoxysilane groups such as a methoxysilane group, an ethoxysilane group and a propoxysilane group. Only one type of alkoxysilane compound (D) may be used, or a combination of two or more types of alkoxysilane compounds (D) may be used.

Specific examples of the alkoxysilane compound (D) include: a γ-glycidoxyalkyltrialkoxysilane such as γ-glycidoxypropyltrimethoxysilane, γ-glycidoxypropyltriethoxysilane and γ-glycidoxypropoxytrimethoxysilane; a γ-methacryloxyalkyltrialkoxysilane such as γ-methacryloxypropyltrimethoxysilane, γ-methacryloxypropyltriethoxysilane and γ-methacryloxypropoxytrimethoxysilane; a γ-aminopropyltrialkoxysilane such as γ-aminopropyltriethoxysilane and γ-aminopropyltripropoxysilane; and a N-phenyl-γ-aminoalkyltrialkoxysilane such as N-phenyl-γ-aminopropyltrimethoxysilane, N-phenyl-γ-aminopropyltriethoxysilane and N-phenyl-γ-aminopropyltripropoxysilane. Among these alkoxysilane compounds (D), γ-glycidoxyalkyltrialkoxysilane, γ-methacryloxyalkyltrialkoxysilane, γ-aminopropyltrialkoxysilane and N-phenyl-γ-aminoalkyltrialkoxysilane are preferred, and γ-glycidoxyalkyltrialkoxysilane, γ-methacryloxyalkyltrialkoxysilane and γ-aminopropyltrialkoxysilane are more preferred, and γ-glycidoxyalkyltrialkoxysilane and γ-methacryloxyalkyltrialkoxysilane are still more preferred.

The alkoxysilane compound (D) may be a compound in which a part of an alkoxysilane group is hydrolyzed andior a compound in which a part of an alkoxysilane group is hydrolyzed and dehydration-condensed.

The content of the alkoxysilane compound (D) is preferably 0.2 to 12% by mass, more preferably 0.5 to 10% by mass (e.g., 1 to 6%/0 by mass), relative to the resin solid content (i.e., 100% by mass) in the water-borne paint composition. When the content of the alkoxysilane compound (D) falls within the above-mentioned range, it becomes possible to produce a water-borne paint composition that can be formed into a coating film having excellent adhesion to an underlying base and therefore exhibiting excellent anti-corrosion properties. If the content of the alkoxysilane compound (D) is too large, curability of the coating film may be deteriorated.

<Other Compounding Components (E)>

The water-borne paint composition according to the present invention can contain another compounding component other than the above-mentioned components, as required. Examples of another compounding component include a pigment, an additive, water and an organic solvent. In the case where the water-borne paint composition according to the present invention is of a two-pack type, another compounding component may be contained in the first agent, or may be contained in the second agent. In the case where the water-borne paint composition according to the present invention is of a two-pack type, another compounding component may be added to the first agent or the second agent prior to mixing of the first agent with the second agent, or may be added after mixing of the first agent with the second agent.

Specific examples of the pigment include: a coloring pigment such as titanium oxide, yellow iron oxide, red iron oxide, carbon black, phthalocyanine blue, phthalocyanine green, azo red, quinacridone red and benzimidazolone yellow, an extender pigment such as calcium carbonate, barium sulfate, kaolin, clay, talc, mica, alumina and alum; and an anti-corrosive pigment such as aluminum tripolyphosphate, zinc phosphate and calcium phosphate. Only one type of pigment may be used, or a combination of two or more types of pigments may be used.

The concentration of the pigment in the water-borne paint composition is preferably 20 to 50% by volume, more preferably 25 to 45% by volume, still more preferably 30 to 40% by volume. If the concentration of the pigment is less than 20% by volume, the effects produced by the addition of the pigment (e.g., anti-corrosion properties (anti-rust properties), improvement in strength of the coating film) may not be developed sufficiently. If the concentration of the pigment is more than 50% by volume, the appearance of the coating film may be deteriorated. The concentration by volume of the pigment can be determined by calculation from the amount of the pigment added and the specific gravities of the components in the paint.

Specific examples of the additive include a dispersant, a viscosity modifier, a curing catalyst, a surface modifier, an antifoaming agent, a plasticizer, a film formation aid, an ultraviolet ray absorber, an antioxidant agent, a leveling agent, a sedimentation inhibitor, an anti-corrosion agent, a reactive diluent and a non-reactive diluent. Only one type of additive may be used, or a combination of two or more types of additives may be used.

Specific examples of the solvent include: a glycol-type solvent such as ethylene glycol, propylene glycol, ethylene glycol monobutyl ether, propylene glycol monobutyl ether, diethylene glycol, dipropylene glycol, diethylene glycol monobutyl ether, dipropylene glycol monobutyl ether and diethylene glycol dibutyl ether: an aromatic solvent such as xylene, Solvesso 100, Solvesso 150 and Solvesso 200; a hydrocarbon-type solvent such as a Mineral Spirit; and an ester-type solvent such as 2,2,4-trimethyl-1,3-pentanediol monoisobutyrate, 2,2,4-trimethyl-1,3-pentanediol diisobutyrate, diethyl adipate and diisobutyl adipate.

<Painting of Water-Borne Paint Composition>

The water-borne paint composition according to the present invention is painted onto an object of interest. In the case where the water-borne paint composition is of a two-pack type, the water-borne paint composition is painted onto an object of interest after mixing of the first agent with the second agent. The material of a surface of an object to be painted may be, for example, a metal (including an alloy thereof), a woody material, a plastic material, a rubber, a stone material, slate, concrete, mortar, a fiber, paper, glass, a ceramic, a pottery, a film and a complex thereof. For example, when the surface of an object to be painted is made from an inorganic material such as slate and concrete, a sealer may be applied onto the surface in advance. The surface of an object to be painted may have an old coating film formed thereon. The water-borne paint composition according to the present invention is preferably applied onto a metal surface or an old coating film or both of a metal surface and an old coating film. Specific examples of the metal include iron, copper, tin, zinc, aluminum and a stainless steel.

Specific examples of the object of which the surface to be painted is a metal or an old coating film include a building (e.g., a civil engineering structure), a ship, a vehicle (e.g., a railway vehicle, a heavy vehicle), an airplane, a bridge, a marine structure, a plant, a tank (e.g., a petroleum tank), a pipe, a steel pipe and a cast iron pipe.

A coating film can be produced by applying the water-borne paint composition onto an object of interest and then drying the applied water-borne paint composition. A method for the application may be selected appropriately depending on the type of the object to be painted (e.g., a base material) and the like. For example, coating using a brush, a roller, an air spray, an airless spray, a trowel or the like, dipping and the like can be employed.

The amount of the water-borne paint composition to be applied may vary depending on the intended use, the type of the object to be applied and the like, and is, for example, 10 to 350 g/m². The thickness of a dried coating film is, for example, 10 to 300 μm and may be 10 to 250 μm or 15 to 200 μm. The water-borne paint composition may be applied multiple times to form a dried coating film having a desired thickness. In this case, a dried coating film having a desired thickness may be formed by applying the water-borne paint composition multiple times to form multiple layers of wet coating films and then drying the wet coating films, or a dried coating film having a desired thickness may be formed by forming multiple layers of dried coating films.

The drying of the coating film can be performed by air-drying. The air-drying can be performed at ambient temperature (25° C. or a temperature around 25° C.) or a temperature lower than ambient temperature. In the case where air-drying is employed, a drying time required for obtaining a completely cured coating film is preferably 2 hours or longer, more preferably 24 hours or longer, still more preferably 1 week or longer. According to the water-borne paint composition of the present invention, a coating film having excellent adhesion to an old coating film, water resistance and anti-corrosion properties can be formed even by carrying out the air-drying at ambient temperature or a temperature lower than ambient temperature.

It is possible to form another coating film prior to and/or after the formation of a coating film by applying the water-borne paint composition according to the present invention. In one embodiment, the water-borne paint composition according to the present invention is painted to form a coating film and then a top coat paint is painted on the coating film to form a top coat layer. When a top coat layer is formed, the appearance, anti-corrosion properties and water resistance can be further improved.

Specific examples of the top coat paint include an epoxy/amine-based paint, a two-pack paint with urethane curing system, a one-pack paint with urethane curing system, a paint with carbodiimide curing system, an acrylic resin based paint, an alkyd resin based paint and a silicone resin based paint. The top coat paint may be of a solvent-borne type or a water-borne type. From the viewpoint of reduction in environmental impact, the top coat paint is preferably of a water-borne type. The top coat paint is more preferably a water-borne two-pack paint with urethane curing system, a water-borne one-pack paint with urethane curing system, a water-borne silicone resin based paint, and a water-borne paint with carbodiimide curing system. When these water-borne paints are used, excellent weather resistance and long-lasting protection of beautiful appearance can be achieved.

The top coat layer can be formed by applying the top coat paint and then drying the applied top coat paint. A method for the application may be selected appropriately depending on the type of the top coat paint and the like. For example, coating using a brush, a roller, an air spray, an airless spray, a trowel or the like, dipping and the like can be employed.

The amount of the top coat paint to be applied may vary depending on the type of the paint, the purpose of the painting and the like, and is, for example, 30 to 400 g/m². The thickness of a dried top coat layer is, for example, 10 to 500 μm, and may be 10 to 300 μm or 10 to 150 μm. The drying of the coating film made from the top coat paint can be performed by air-drying, forced drying, baking or the like.

Prior to the formation of the coating film with the water-borne paint composition according to the present invention, an under coat paint may be applied on a surface of the object to be painted to form an under coat layer. When the under coat layer is formed, excellent anti-corrosion properties and water resistance can be achieved and the requirements for high anti-corrosion properties in a bridge, a plant, a tank or the like can be satisfied sufficiently.

The under coat paint is, for example, an organic or inorganic zinc-rich paint. The under coat paint may be of a solvent-borne type or a water-borne type. From the viewpoint of reduction in environmental impact, the under coat paint is preferably of a water-borne type.

For the formation of the under coat layer, the same method as that employed for the formation of the top coat layer can be employed. The amount of the under coat paint to be applied may vary depending on the type of the paint, the purpose of the painting and the like, and is, for example, 80 to 1200 g/m². The thickness of a dried under coat layer is, for example, 20 to 300 μm, and may be 20 to 200 μm. The drying of the coating film made from the under coat paint can be performed by air-drying, forced drying, baking or the like.

After the application of the water-borne paint composition according to the present invention to form the coating film, it is possible to apply an intermediate coat paint on the coating film to form an intermediate coat layer. When the intermediate coat layer is formed, a coating film having excellent anti-corrosion properties and water resistance can be produced. It is preferred to form the top coat layer on the intermediate coat layer.

Examples of the intermediate coat paint include an epoxy/amine-based paint, a two-pack paint with urethane curing system and a one-pack paint with urethane curing system. The intermediate coat paint may be of a solvent-borne type or of a water-borne type. From the viewpoint of reduction in environmental impact, the intermediate coat paint is preferably of a water-borne type. The intermediate coat paint is more preferably a water-borne epoxyiamine-based paint or a water-borne two-pack paint with urethane curing system. When a water-borne paint of this type is used, a stiff multi-layer coating film having good cohesiveness to the top coat layer can be formed.

For the formation of the intermediate coat layer, the same method as that employed for the formation of the top coat layer can be employed. The amount of the intermediate coat paint to be applied may vary depending on the type of the paint, the purpose of the painting and the like, and is, for example, 20 to 400 g/m². The thickness of a dried intermediate coat layer is, for example, 10 to 200 μm, and may be 10 to 100 μm.

Each of the top coat paint, the intermediate coat paint and the under coat paint can contain a pigment, an additive or the like. Specific examples of the pigment, the additive and the like are as mentioned for the water-borne paint composition according to the present invention.

### EXAMPLES

Hereinbelow, the present invention will be described in more detail by way of Examples and Comparative Examples. However, the present invention is not intended to be limited by the following examples. In the following examples, all parts are by mass and all percents (%) are by mass unless otherwise specified.

### [1] Production of Water-Borne Paint Compositions

### Production Example 1: Preparation of Water-Borne Epoxy-Based Amine Resin (A3-1) I

Into a reaction vessel equipped with a stirrer, a condenser, a nitrogen inlet tube and a thermometer were introduced 742 parts of a raw material resin that was synthesized from bisphenol A and epichlorohydrin and had an epoxy equivalent of 188 g/equivalent, 336 parts of bisphenol A and 190 parts of methyl isobutyl ketone (also referred to as “MIBK”, hereinafter). The components were reacted with one another at 117° C. in the presence of 1 part of benzyldimethylamine until the epoxy equivalent became 1079 g/equivalent to produce an epoxy resin. Subsequently, 360 parts of a ketimine compound of diethylenetriamine (73% by mass, a solution in MIBK) was added to the reaction mixture, and the resultant mixture was reacted at 117° C. for 1 hour. Subsequently, 27 parts of ion-exchanged water and 188 parts of glycidyl neodecanoate ester (a product manufactured by Hexion Specialty Chemicals Inc., product name: “CARDURA E10-P”) were introduced into the reaction vessel, and the resultant mixture was reacted at 100° C. for 2 hours. Subsequently, the resultant mixture was diluted with MIBK until a non-volatile matter content became 75% to produce an epoxy-based amine resin having an amine equivalent of 1095. Subsequently, acetic acid was added to the mixture so that the above-defined neutralization ratio became 35%, and then the resultant mixture was diluted with ion-exchanged water.

Subsequently, a mixture of MIBK and water was removed from the mixture under reduced pressure until a solid content became 40% by mass to produce a milky white water-borne (water dispersion type) epoxy-based amine resin (A3-1) I. The amine equivalent of the water-borne epoxy-based amine resin (A3-1) I was calculated from the amount of the raw material compounded.

### Production Example 2: Preparation of Water-Borne Epoxy-Based Amine Resin (A3-1) II

Into a reaction vessel equipped with a stirrer, a condenser, a nitrogen inlet tube and a thermometer were introduced 1940 parts of a raw material resin that was synthesized from bisphenol A and epichlorohydrin and had an epoxy equivalent of 188 g/equivalent, 1060 parts of bisphenol A and 1000 parts of methyl isobutyl ketone (also referred to as “MIBK”, hereinafter). The components were reacted with one another at 117° C. in the presence of 8 parts of benzyldimethylamine until the epoxy equivalent became 3000 g/equivalent to produce an epoxy resin. Subsequently, 360 parts of a ketimine compound of diethylenetriamine (73% by mass, a solution in MIBK) was added to the reaction mixture, and the resultant mixture was reacted at 117° C. for 1 hour. Subsequently, the resultant mixture was diluted with MIBK until a non-volatile matter content became 60% to produce an epoxy-based amine resin having an amine equivalent of 1550. Subsequently, acetic acid was added to the mixture so that the above-defined neutralization ratio became 40%, and then the resultant mixture was diluted with ion-exchanged water. Subsequently, a mixture of MIBK and water was removed from the mixture under reduced pressure until a solid content became 40% by mass to produce a milky white water-borne (water dispersion type) epoxy-based amine resin (A3-1) II. The amine equivalent of the water-borne epoxy-based amine resin (A3-1) II was calculated from the amount of the raw material compounded.

The amine equivalents, number average molecular weights in terms of standard polystyrene as measured by GPC and states of the water-borne epoxy-based amine resins (A3-1) produced in Production Examples 1 and 2, the epoxy equivalents of the epoxy resins that formed the water-borne epoxy-based amine resins (A) and others are summarized in Table 1.

TABLE 1

| | Production Example | |
|---|---|---|
| | 1 | 2 |
| Water-borne epoxy-based amine resin (A3-1) | I | II |
| Neutralization ratio (%) | 35 | 40 |
| Solid content (% by mass) | 40 | 40 |
| Amine equivalent | 1095 | 1550 |
| Number average molecular weight (GPC) | 2300 | 6200 |
| Epoxy equivalent of epoxy resin | 1079 | 3000 |
| State | Dispersed | Dispersed |
| | in water | in water |

### Production Example 3: Preparation of Water-Borne Acrylic Resin (A1) IV

Into a reaction vessel equipped with a stirrer, a nitrogen inlet tube, a temperature regulator, a condenser and a dropping funnel was introduced 200.0 parts of deionized water. The temperature of deionized water was raised to 80° C. while stirring under a nitrogen atmosphere. To the deionized water a pre-emulsion was added dropwise together with an aqueous initiator solution over 2 hours. The pre-emulsion was prepared by adding 236.3 parts of 2-ethylhexyl acrylate, 538.0 parts of methyl methacrylate, 200.0 parts of styrene, 25.7 parts of acrylic acid and 100 parts of “LATEMUL PD-104” (a product manufactured by Kao Corporation, a 20% aqueous solution) that served as an emulsifying agent to 579.4 parts of deionized water and emulsifying the resultant mixture. The aqueous initiator solution was prepared by dissolving 3 parts of ammonium persulfate in 150 parts of deionized water. After the completion of the dropwise addition, the reaction was further continued at 80° C. for 1 hour, then the resultant mixture was cooled, and then 8.2 parts of N, N-dimethylaminoethanol was added thereto (neutralization ratio: 100%) to produce a water-borne acrylic resin (A1) IV which was an anionic acrylic resin emulsion (A1-1) having a resin solid content of 50% by mass. The water-borne acrylic resin (A1) IV had a resin solid content acid value of 20 mgKOH/g and a glass transition temperature Tg of 40° C. as calculated from the monomer composition thereof.

### Production Example 4: Preparation of Water-Borne Acrylic Resin (A1) V

Into a reaction vessel equipped with a stirrer, a nitrogen inlet tube, a temperature regulator, a condenser and a dropping funnel was introduced 259.0 parts of 2-methoxy-1-propanol. The temperature of 2-methoxy-1-propanol was raised to 120° C. while stirring under a nitrogen atmosphere. To the 2-methoxy-1-propanol a monomer mixture of 35.0 parts of styrene, 19.8 parts of methyl methacrylate, 155.2 parts of n-butyl acrylate, 19.0 parts of ethyl acrylate, 137.2 parts of 2-ethylhexyl acrylate and 33.8 parts of methacrylic acid was added dropwise together with an initiator solution, which was prepared by dissolving 16.0 parts of “Kayaester O” (t-butylperoxy-2-ethylhexanate, manufactured by Kayaku Akzo Corporation) in 25.0 parts of 2-methoxy-1-propanol, over 3 hours. After the completion of the dropwise addition, the mixture was retained at 120° C. for 0.5 hour, then an initiator solution, which was prepared by dissolving 1.6 parts of “Kayaester O” in 16.0 parts of 2-methoxy-1-propanol, was added dropwise thereto over 0.5 hour, and then the resultant mixture was further stirred at 120° C. for 1 hour. Subsequently, the mixture was cooled to 60° C. and was then neutralized with 35.0 parts of N,N-dimethylethanolamine (neutralization ratio, 100%), and then 287.4 parts of deionized water was added thereto to prepare an aqueous solution, thereby producing a water-borne acrylic resin (A1) V which was an aqueous anionic acrylic resin solution having a resin solid content of 40% by mass. The water-borne acrylic resin (A1) V had a resin solid content acid value of 55 mgKOH/g and a glass transition temperature Tg of −35° C. as calculated from the monomer composition thereof.

### Production Example 5: Preparation of Water-Borne Acrylic Resin (A1) VI

Into a four-neck flask equipped with a stirrer, a reflux condenser, a dropping funnel and a thermometer were introduced 150 parts of ion-exchanged water and 4 parts of a diallylalkylethanol ammonium chloride (“ADEKA NOL SDX-236”, manufactured by ADEKA Corporation) that served as a reactive emulsifying agent. Subsequently, the temperature of the resultant mixture was raised to 75° C. while stirring and blowing a nitrogen gas thereinto. Subsequently, 4 parts of a 10% aqueous solution of 2,2′-azobis(2-aminodipropane) dihydrochloride was added as a polymerization initiator to the mixture, then a monomer mixture composed of 5 parts of dimethylaminoethyl methacrylate, 47 parts of butyl acrylate, 10 parts of methyl methacrylate and 30 parts of styrene was added dropwise into the flask over 3 hours, and then the reaction was further continued at 75° C. for 3 hours. Subsequently, acetic acid was added to neutralize the mixture at a neutralization ratio of 100% to produce a water-borne acrylic resin (A1) VI that was a cationic acrylic resin emulsion (A-2) having a resin solid content of 40% by mass. The degree of amination of the resin contained in the product was 20.

### Production Example 6: Preparation of Water-Borne Acrylic Resin (A1) VII

Into a reaction vessel equipped with a stirrer, a condenser, a nitrogen inlet tube, a thermometer and a dropping funnel was introduced 670 parts of MIBK. The temperature of MIBK was raised to 110° C. A solution composed of 500 parts of styrene, 400 parts of n-butyl acrylate, 180 parts of dimethylaminoethyl methacrylate, 100 parts of MIBK and 20 parts of “Kayaester O” (t-butylperoxy-2-ethylhexanate, manufactured by Kayaku Akzo Corporation) was added dropwise to the reaction vessel over 3 hours. After the completion of the dropwise addition, the resultant mixture was retained at 110° C. for 30 minutes, and then a solution composed of 2 parts of t-butyl peroctoate and 50 parts of MIBK was added dropwise thereto over 30 minutes. After the completion of the dropwise addition, the reaction was further continued at 110° C. for 1 hour to produce a resin having a number average molecular weight of 10000 and an amine equivalent of 940 (amine value: 60). Subsequently, acetic acid was added to the mixture so as to achieve 100% of a neutralization ratio (a ratio of neutralization of an amine group in the resin), and then ion-exchanged water was added to the resultant mixture to dilute the mixture. Subsequently, a mixture of MIBK and water was removed under a reduced pressure until the resin solid content became 40% by mass to produce a water-borne acrylic resin (A1) VII that was a cationic acrylic resin aqueous solution.

### Production Example 7: Preparation of Water-Borne Acrylic Resin (A1) VIII

Into a reaction vessel equipped with a stirrer, a nitrogen inlet tube, a temperature regulator, a condenser and a dropping funnel were introduced 200.0 parts of deionized water and 70 parts of “Newcol 740 (60)” (a product manufactured by Nippon Nyukazai Co., Ltd.; a 60% aqueous solution) that served as an emulsifying agent. The temperature of the resultant mixture was raised to 80° C. while stirring under a nitrogen atmosphere. To the resultant mixture a pre-emulsion was added dropwise together with an aqueous initiator solution over 2 hours. The pre-emulsion was prepared by adding 236.3 parts of 2-ethylhexyl acrylate, 538.0 parts of methyl methacrylate, 225.7 parts of styrene, and 100 parts of Newcol 740 (60) to 579.4 parts of deionized water and emulsifying the resultant mixture. The aqueous initiator solution was prepared by dissolving 3 parts of ammonium persulfate in 150 parts of deionized water. After the completion of the dropwise addition, the reaction was further continued at 80° C. for 1 hour to produce a water-borne acrylic resin (A1) VIII which was a nonionic acrylic resin emulsion (A1-3) having a resin solid content of 50% by mass. The water-borne acrylic resin (A1) VIII has a glass transition temperature Tg of 40° C. as calculated from the monomer composition thereof.

The states, polymerization methods, acid values, amine values, neutralization ratios and others of the water-borne acrylic resins (A1) produced in Production Examples 3 to 7 are summarized in Table 2.

TABLE 2

| | Production Example | | | | |
|---|---|---|---|---|---|
| | 3 | 4 | 5 | 6 | 7 |
| No. | IV | V | VI | VII | VIII |
| Ionicity of water-borne acrylic resin | Anionic | Anionic | Cationic | Cationic | Nonionic |
| Method for polymerization of | Emulsion | Solution | Emulsion | Solution | Emulsion |
| water-borne acrylic resin | polymerization | polymerization | polymerization | polymerization | polymerization |
| Acid value of water-borne acrylic resin | 20 | 55 | — | — | — |
| Amine value of water-borne acrylic resin | — | — | 20 | 60 | — |
| Neutralizing agent | N,N-Dimethylethanolamine | | Acetic acid | | — |
| Neutralization ratio (%) | 100 | 100 | 100 | 100 | — |
| Resin solid content (% by mass) | 50 | 40 | 40 | 40 | 50 |
| State | Dispersed | Dissolved | Dispersed | Dissolved | Dispersed |
| | in water | in water | in water | in water | in water |

### Production Example 8: Preparation of Emulsion XIV Containing Compound Having (Meth)Acryloyl Group

35 parts of water, 10 parts of dipropylene glycol monobutyl ether, 5 parts of a nonionic emulsifying agent [a product manufactured by Nippon Nyukazai Co., Ltd., product name: “Newcol 740” ] and 50 parts of propoxylated trimethylolpropane triacrylate (PO3 mol) [viscosity (25° C.): 85 mPa-s, molecular weight: 470, number of functional groups: 3, acryloyl group equivalent: 157] were mixed together, and the resultant mixture was stirred with a homogenizer for 10 minutes to produce an emulsion XIV that contained a compound having a (meth)acryloyl group. The term “PO3 mol” means that there are three propylene oxide units in a molecule thereof. The emulsion XIV was used as a curing agent.

### Examples 1 to 13, Comparative Examples 1 to 4

80 parts of water, 25 parts of a pigment dispersant (a product manufactured by BYK-Chemie, product name: “Disperbyk-190”), 75 parts of talc, 40 parts of calcium carbonate, 170 parts of titanium oxide and 20 parts of a phosphate-type anti-corrosive pigment were mixed together, and the resultant mixture was stirred using a disper for 30 minutes to produce a pigment-dispersed paste. Subsequently, compounding components for a first agent (a main agent) shown in Table 3 or 4 (in compounding amounts shown in Table 3 or 4) and 410 parts of the above-produced pigment-dispersed paste were mixed together using a disper. Subsequently, 50 parts of dipropylene glycol monobutyl ether and 5 parts of an associative thickener (a product manufactured by ADEKA Corporation, product name: “ADEKA NOL UH-420”) were added to and mixed with the mixture to prepare a first agent (a main agent).

In some Examples, curing agents shown in Table 3 or 4 (in compounding amounts shown in Table 3 or 4) were provided as second agents. In this manner, one-pack or two-pack water-borne paint compositions were produced.

### Examples 14 to 18, Comparative Examples 5 to 12

Compounding components for first agents (main agents) shown in Table 3 or 4 (in compounding amounts shown in Table 3 or 4) were mixed together using a disper (in the case where only one compounding component was used, the compounding component was used without any modification). Subsequently, 50 parts of dipropylene glycol monobutyl ether was added to and mixed with the resultant mixture. In this manner, first agents (main agents) were prepared.

The unit for each of the compounding amounts shown in Table 3 or 4 is “part(s) by mass”. Each of the compounding amounts shown in Table 3 or 4 is not an amount in terms of a solid content but a net weight. The details of the abbreviations of the compounding components shown in Table 3 or 4 are as follows.

(a) Water-borne epoxy resin (A2) III: “ADEKA RESIN EM-101-50” (an emulsion of a bisphenol A-type epoxy resin, solid content: 47% by mass, epoxy equivalent: 500 g/equivalent, number average molecular weight: 1000) manufactured by ADEKA corporation,

(b) Emulsion (B) IX of EVA: “Polysol EVA AD-92” (solid content: 56% by mass, ethylene content ratio: 5% by mass) manufactured by Showa Denko K. K.,

(c) Emulsion (B) X of EVA: “Polysol EVA AD-2” (solid content: 56% by mass, ethylene content ratio: 14% by mass) manufactured by Showa Denko K. K.,

(d) Emulsion (B) XI of EVA: “Polysol EVA AD-20” (solid content: 56% by mass, ethylene content ratio: 300% by mass) manufactured by Showa Denko K. K.,

(e) Alkoxysilane compound (D) XII: “Dynasylan MEMO” (3-methacryloxypropyltrimethoxysilane, solid content: 100/o by mass) manufactured by EVONIK INDUSTRIES,

(f) Epoxy-group-containing curing agent XIII: “ADEKA RESIN EM-101-50” (an emulsion of a bisphenol A-type epoxy resin, solid content: 47% by mass, epoxy equivalent: 500 g/equivalent, number average molecular weight: 1000) manufactured by ADEKA corporation, and

(g) Amino-group-containing curing agent XV: “Fujicure FXS-918-FA” (an epoxy adduct-type modified polyamine resin, solid content: 60% by mass, amine equivalent: 387) manufactured by T&K TOKA Corporation.

[2] Assessment of Water-Borne Paint Compositions

The water-borne paint compositions thus produced were assessed by the following methods. The results are shown in Tables 3 and 4.

(Adhesion of Coating Films to Existing Coating Films)

A polished steel plate was used as a base. “Hipon Fine Primer II” (a product manufactured by Nippion Paint Co., Ltd.) was applied, as an anti-corrosive paint, onto the polished steel plate using an air spray at a dried film thickness of 50 μm, and then dried for 1 day. “Fine Urethane U100” (a product manufactured by Nippon Paint Co., Ltd.) was applied onto the film formed form the anti-corrosive paint using a brush at a dried film thickness of 60 lam. Subsequently, the resultant product was aged for 3000 hours by an accelerated weather resistance method (a xenon arc lamp method) in accordance with JIS K 5600-7-7 to produce an existing (old) coating film. Subsequently, the first agent and the second agent for a two-pack water-borne paint composition were mixed together using a disper, and the resultant mixture was applied onto the old coating film using a brush in an application amount of 200 g/m². The resultant product was dried under the environment of 23° C. for 168 hours to produce a test plate having a coating film made from the water-borne paint composition. The test plate was subjected to an adhesion test by a cross-cut method in accordance with JTS K 5600-5-6, and was then assessed based on the following criteria.

0: Cut edges were completely smooth, and delamination was not observed in any grid.

1: Slight delamination of a coating film was observed at intersections of cut lines, and the area of delaminated parts was less than 5%.

2: The area of delaminated parts was greater than or equal to 5% and less than 15%.

3: The area of delaminated parts was greater than or equal to 15% and less than 35%.

4: The area of delaminated parts was greater than or equal to 35% and less than 65%.

5: The area of delaminated parts was greater than or equal to 65%.

(Anti-Corrosion Properties of Coating Films)

With respect to each of the two-pack type water-borne paint compositions, the first agent and the second agent were mixed together using a disper, and the resultant mixture was applied onto a polished steel plate in an application amount of 200 g/m² using a brush and was then dried under the environment of 23° C. for 168 hours to produce a test plate having a coating film formed from the water-borne paint composition. The test plate was subjected to a cycle corrosion test (120 cycles, 720 hours) in accordance with cycle D in JIS K 5600-7-9, and was then assessed based on the following criteria.

AA: Occurrence of corrosion was not observed.

A: Occurrence of corrosion was observed in an area of less than 0.05%.

B: Occurrence of corrosion was observed in an area of greater than or equal to 0.05%.

(Water Resistance of Coating Films)

With respect to each of the two-pack type water-borne paint compositions, the first agent and the second agent were mixed together using a disper, and the resultant mixture was applied onto a fiber-reinforced cement plate in an application amount of 120 g/m² using a brush and was then dried under the environment of 23° C. for 168 hours to produce a test plate having a coating film formed from the water-borne paint composition. The test plate was subjected to a water resistance test (dipping in water for 96 hours) in accordance with JIS K 5600-6-17, and was then assessed based on the following criteria.

A: No change in color/gloss was observed at a water level before and after the test.

B: Change in color/gloss was observed at a water level before and after the test.

(Adhesion of Coating Films to Top Coat Coating Films)

With respect to each of the two-pack water-borne paint compositions, the first agent and the second agent were mixed together using a disper, and the resultant mixture was applied onto a polished steel plate in an application amount of 140 g/m² using a brush and was then dried under the environment of 23° C. for 24 hours to produce a test plate having a coating film formed from the water-borne paint composition. Subsequently, a water-borne silicone-based paint (“O-DE FRESH Si100III”, manufactured by Nippon Paint Co., Ltd.) was applied as a top coat paint onto the coating film using a brush at an application amount of 140 g/m² and was then dried under the environment of 23° C. for 168 hours to form a top coat coating film on the test plate. The test plate was subjected to an adhesion test by a cross-cut method in accordance with JIS K 5600-5-6, and was then assessed with respect to the adhesion to the top coat coating film based on the following criteria.

0: Cut edges were completely smooth, and delamination was not observed in any grid.

1: Slight delamination of a coating film was observed at intersections of cut lines, and the area of delaminated parts was less than 5%.

2: The area of delaminated parts was greater than or equal to 5% and less than 15%.

3: The area of delaminated parts was greater than or equal to 15% and less than 35%.

4: The area of delaminated parts was greater than or equal to 35% and less than 65%.

5: The area of delaminated parts was greater than or equal to 65%.

TABLE 3

| | | | Example | | | | | | | | | |
|---|---|---|---|---|---|---|---|---|---|---|---|---|
| | | | 1 | 2 | 3 | 4 | 5 | 6 | 7 | 8 | 9 | 10 |
| First agent | Water-borne epoxy-based | I | | | | 81 | 302 | 81 | 81 | 81 | 81 | 81 |
| (main agent) | amine resin (A3-1) | II | 403 | 403 | 403 | 322 | 81 | 322 | 322 | 322 | 322 | 322 |
| | Water-borne epoxy resin (A2) | III | | | | | | | | | | |
| | Water-borne acrylic resin (A1) | IV | | | | | | | | | | |
| | | V | | | | | | | | | | |
| | | VI | | | | | | | | | | |
| | | VII | | | | | | | | | | |
| | | VIII | | | | | | | | | | |
| | Emulsion (H) of EVA | IX | 20 | | | | | | | | | |
| | | X | | 20 | | 20 | | 248 | 20 | 27 | 27 | 25 |
| | | XI | | | 20 | | 20 | | | | | |
| | Alkoxysilane compound (D) | XII | | | | | | | 15 | | 1.6 | 1.6 |
| Second | Epoxy-group-containing | XIII | | | | | | | | 148 | 148 | |
| agent | curing agent | | | | | | | | | | | |
| | (Meth)acryloyl-group- | XIV | | | | | | | | | | 104 |
| | containing curing agent | | | | | | | | | | | |
| | Amino-group-containing | XV | | | | | | | | | | |
| | curing agent | | | | | | | | | | | |

| Content of EVA in resin solid material (% by mass) | | 6 | 6 | 6 | 6 | 7 | 46 | 6 | 6 | 6 | 6 |
|---|---|---|---|---|---|---|---|---|---|---|---|
| Assessment | Adhesion to old coating film | 1 | 1 | 1 | 1 | 1 | 1 | 1 | 1 | 0 | 0 |
| | Anti-corrosion properties | A | AA | AA | AA | AA | AA | AA | AA | AA | AA |
| | Water resistance | — | — | — | — | — | — | — | — | — | — |
| | Adhesion to top coat coating film | 1 | 1 | 1 | 1 | 1 | 1 | 0 | 1 | 0 | 0 |

| | | | Example | | | | | | | |
|---|---|---|---|---|---|---|---|---|---|---|
| | | | 11 | 12 | 13 | 14 | 15 | 16 | 17 | 18 |
| First agent | Water-borne epoxy-based | I | | | | | | | | |
| (main agent) | amine resin (A3-1) | II | | | 341 | | | | | |
| | Water-borne epoxy resin (A2) | III | 500 | 500 | | | | | | |
| | Water-borne acrylic resin (A1) | IV | | | | 500 | | | | |
| | | V | | | | | 500 | | | |
| | | VI | | | | | | 500 | | |
| | | VII | | | | | | | 500 | |
| | | VIII | | | 50 | | | | | 500 |
| | Emulsion (H) of EVA | IX | | | | | | | | |
| | | X | 200 | 200 | 20 | 150 | 150 | 150 | 150 | 150 |
| | | XI | | | | | | | | |
| | Alkoxysilane compound (D) | XII | | | | | | | | |
| Second | Epoxy-group-containing | XIII | | | | | | | | |
| agent | curing agent | | | | | | | | | |
| | (Meth)acryloyl-group- | XIV | | | | | | | | |
| | containing curing agent | | | | | | | | | |
| | Amino-group-containing | XV | | 10 | | | | | | |
| | curing agent | | | | | | | | | |

| Content of EVA in resin solid material (% by mass) | | 31 | 31 | 6 | 25 | 25 | 25 | 25 | 25 |
|---|---|---|---|---|---|---|---|---|---|
| Assessment | Adhesion to old coating film | 1 | 0 | 1 | 1 | 1 | 1 | 1 | 1 |
| | Anti-corrosion properties | A | A | AA | — | — | — | — | — |
| | Water resistance | — | — | — | A | A | A | A | A |
| | Adhesion to top coat coating film | 1 | 1 | 1 | 1 | 1 | 1 | 1 | 1 |

TABLE 4

| | | | Comparative Example | | | | | | | | | | | |
|---|---|---|---|---|---|---|---|---|---|---|---|---|---|---|
| | | | 1 | 2 | 3 | 4 | 5 | 6 | 7 | 8 | 9 | 10 | 11 | 12 |
| First agent | Water-borne epoxy-based amine resin | I | | | | | | | | | | | | |
| (main agent) | (A3-1) | II | 403 | 403 | | | | | | | | | | |
| | Water-borne epoxy resin (A2) | III | | | 500 | 500 | | | | | | | | |
| | Water-borne acrylic resin (A1) | IV | | | | | 500 | 500 | | | | | | |
| | | V | | | | | | | 500 | 500 | | | | |
| | | VI | | | | | | | | | 500 | 500 | | |
| | | VII | | | | | | | | | | | 500 | 500 |
| | | VIII | | | | | | | | | | | | |
| | Emulsion (B) of EVA | IX | | | | | | | | | | | | |
| | | X | | 485 | | 600 | | 600 | | 600 | | 600 | | 600 |
| | | XI | | | | | | | | | | | | |
| | Alkoxysilane compound (D) | XII | | | | | | | | | | | | |
| Second | Epoxy-group-containing curing agent | XIII | | | | | | | | | | | | |
| agent | (Meth)acryloyl-group-containing | XIV | | | | | | | | | | | | |
| | curing agent | | | | | | | | | | | | | |
| | Amino-group-containing curing agent | XV | | | | | | | | | | | | |

| Content of EVA in resin solid material (% by mass) | | — | 63 | — | 57 | — | 57 | — | 57 | — | 57 | — | 57 |
|---|---|---|---|---|---|---|---|---|---|---|---|---|---|
| Assessment | Adhesion to old coating film | 4 | 1 | 4 | 1 | 4 | 1 | 4 | 1 | 4 | 1 | 4 | 1 |
| | Anti-corrosion properties | AA | B | A | B | — | — | — | — | — | — | — | — |
| | Water resistance | — | — | — | — | A | B | A | B | A | B | A | B |
| | Adhesion to top coat coating film | 1 | 4 | 1 | 4 | 1 | 4 | 1 | 4 | 1 | 4 | 1 | 4 |

1. An air-drying type water-borne paint composition comprising:
a water-borne resin (A); and
an emulsion (B) of an ethylene-vinyl acetate copolymer having an ethylene content ratio of 5 to 50% by mass,
wherein a content of the ethylene-vinyl acetate copolymer is 5 to 50% by mass, relative to a resin solid content in the air-drying type water-borne paint composition.

2. The air-drying type water-borne paint composition according to claim 1, wherein the water-borne resin (A) comprises a water-borne resin selected from the group consisting of a water-borne acrylic resin (A1), a water-borne epoxy resin (A2) and a water-borne amine resin (A3).

3. The air-drying type water-borne paint composition according to claim 2, wherein the water-borne amine resin (A3) is a water-borne epoxy-based amine resin that is an amine-modified product of an epoxy resin.

4. The air-drying type water-borne paint composition according to claim 3, wherein the epoxy resin has a molecular weight of greater than or equal to 2000.

5. The air-drying type water-borne paint composition according to claim 1, wherein the air-drying type water-borne paint composition is a two-pack water-borne paint composition comprising a first agent containing the water-borne resin (A) and a second agent containing a curing agent (C).

6. The air-drying type water-borne paint composition according to claim 5, wherein the curing agent (C) comprises a compound having a functional group selected from the group consisting of a (meth)acryloyl group, an epoxy group and an amino group.

7. The air-drying type water-borne paint composition according to claim 5, wherein the curing agent (C) is a water-borne curing agent.

8. The air-drying type water-borne paint composition according to claim 1, further comprising an alkoxysilane compound (D).
